(19) United States
(12) Patent Application Publication
(10) Pub. No.: US 2006/0112428 A1
(43) Pub. Date: May 25, 2006

(54) Device having a locking feature and a method, means and software for utilizing the feature

(75) Inventor: Esa Etelapera, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/996,337

(22) Filed: Nov. 23, 2004

(51) Int. Cl. G06F 12/14; G06F 11/00; G06F 12/00; G06F 1/26; G06F 13/00; G08B 13/00; G06F 17/30; G08B 21/00; G06F 7/04; G08B 29/00; G06F 7/58; G06K 19/00; G11C 7/00; H04L 9/32

(52) U.S. Cl. 726/16; 726/34

(57) ABSTRACT

The invention concerns mobile devices having a locking feature for disabling properties and/or functions of the devices. According to invention a mobile device having an ability to be locked, includes at least two separate locking modes having different locking features. The locking modes are associable to a certain feature, which is determinable in the device. The currently valid locking mode, according to which the device is locked, is determined according to the association.

### TECHNICAL FIELD

The invention concerns mobile devices having a locking feature for disabling properties and/or functions of the devices.

### BACKGROUND OF THE INVENTION

Most mobile devices, such as mobile phones, smart phones, communicators and alike, have a device lock which enables locking the device. Locking prevents unauthorised access to a mobile device. Typically, a lock feature of a device means that functioning of the device is disabled. Locking is implemented usually by entering a certain locking code. The user may determine a secret code in order to prevent unwanted access to his device. Re-entering the locking code releases, i.e. opens the lock. Releasing the lock is thus possible only for those knowing the locking code of the device.

Sometimes the device lock is combined with locking feature for locking the keyboard of the device. This is a so called key guard, which prevents accidental key presses, which may occur when device is carried e.g. in a pocket or in a bag. Typically, a keyboard can be locked with a two-key code, e.g. Menu #. In certain devices, the keyboard is guarded with a movable shield, which is glided or turned over the keyboard when the keyboard is not used.

Commonly locking a device can mean locking the keys, i.e. preventing accidental key presses, or locking the device, i.e. preventing unauthorised access or use, or a combination of these two. The device-specific locking mode is used, when the locking is performed. The user may lock his device manually, or the device may lock automatically. The performed locking function is typically set and specified in settings of the device, which are not accessible by the user. The settings determine how the locking is implemented and performed. Different situations, environments and users typically have different requirements regarding the locking feature.

In prior art solutions different locking features are not accessible through the user interface, since locking features are device-specific properties, which are determined during manufacturing phase. Typically, authorised service or maintenance is required for modifying such properties.

### SUMMARY OF THE INVENTION

The objective of the present invention is enhancing the locking features of mobile devices. A further objective of the present invention is to make locking feature more versatile and user-friendly. Another objective of the present invention is to enable the user to choose the currently used locking mode.

The objective is achieved by providing to a mobile device at least two separate locking modes having different locking features, a locking mode associated to a certain feature, which is determinable in the device, such that the currently valid locking mode, according to which the device is locked, is selected according to the association between the feature and the locking mode.

According to an embodiment of the invention, there is presented a mobile device having the ability to be locked, including at least two separate locking modes having different locking features, associated to a certain feature, which is determinable in the device, so that the currently valid locking mode, according to which the device is locked, is selected according to the association between the feature and the locking mode. A mobile device according to an embodiment includes a first locking mode having a key locking function for enabling handy and flexible use, and a second locking mode having a safe locking and closing function for protecting the device from an unauthorized access.

The currently valid locking mode is checked as a response to a triggered locking event. Typically, devices are locked manually. Locking is implemented typically by entering certain predetermined lock code. The device can be also locked automatically for example after certain time period of inactivity. If the device detects no inputs or other activity by the user for a certain predetermined time period, the device is locked automatically. This prevents unauthorised use effectively also when the device is mistakenly left to some place or the user forgets to utilize the locking property of his device.

According to an embodiment of the invention, certain security levels are determined. The user typically determines a security level needed according to usage environment. This security level, typically determined as secure or insecure, depends usually on outer circumstances around the device. Locking modes having different features can be utilized according to determined, required security level. According to an embodiment there is a low security level, which is typically used in safe and secure situations and environments, where it is enough to lock only keys of the device. Usually this security level is associated e.g. to the user profile to be used in certain safe environment or situation, or to a predetermined safe location. The user makes the associations between security levels and user profiles, or between security levels and locations, he considers employable. According to an embodiment, a high security level is also presented, which is typically used in insecure situations, when extra protection against unauthorized use and access is needed. In these situations, the device is locked for protecting the device from an unauthorized access. The high security level is typically associated to the predetermined insecure place or location, or to the user profile to be used in insecure situations or places.

According to an embodiment of the invention, a locking mode is associated to a certain predetermined location of the device. Typically, location of a mobile device can be traced and determined. According to the embodiment, certain places are determined as insecure, thus requiring safe locking of the device. The safe locking mode can be associated to such predetermined places or locations. When it is detected that a device appears in such insecure location, safe locking mode associated to such place is employed, when the locking event is triggered.

According to an embodiment, a locking mode is associated to the user profile. The user can have for example so called office profile to be used in daily work and other safe environments. It is enough to associate a key locking mode to the office profile, or to another profile for safe and secure situations and environments. According to an embodiment, the user can also have so called free time profile in order to change settings when the device is used during free time. Typically, free time activities are not always implemented in safe and secure environments, but there can be congestion and poor lightning or other doubtful or even risky places or situations. Thus, the free time profile is in this example determined as insecure and the safe locking code preventing unauthorised access is associated to the profile. The device is locked according to safe locking mode, when the free time user profile is valid to be used and the locking event is triggered.

The present invention has the advantages that the user may determine used locking modes easily and rapidly. The locking modes associated by the user to a certain feature of the device are then chosen automatically according to the currently valid feature, e.g. the user profile or a detected location of the user device. Thus, the locking mode to be used is chosen automatically. The device lock is good and safe in insecure situations. The user knows that his device is untouchable and inaccessible, when locked with the user-specific secret locking code. In safe environments the device lock seems uncomfortable, since typically the lock code has to be entered every time the locking is deactivated. Nevertheless, locking the keys for preventing accidental key presses is needed every time the mobile device is moved or carried in some media, e.g. in a bag or a pocket. According to the embodiments, mistakenly made key presses are avoided by locking only the keyboard without a need to open the lock with the secret code.

An embodiment of associating a locking mode to a user profile has an advantage that profiles are easy to use and the users are already familiar with the profiles and profile settings. Also, profiles are typically changed anyway, for example to change ringing tone suitable for environment. So locking modes and possibly also security levels associated with profiles are changed automatically correspondingly without requiring any extra operations from the user.

An embodiment of associating a locking mode and possibly also a security level to a certain predetermined location is advantageous especially for people visiting regularly places requiring safe, or certain kind of, determined locking mode to be used. In the embodiment, no operation or input is required from the user after the association between the locking mode and the location is made. The current location information is determined automatically after locking event is triggered, and compared to the predetermined locations in order to find the locking mode associated to the predetermined location corresponding to the determined current location.

### BRIEF DESCRIPTION OF DRAWINGS

In the following the invention is described in detail with the accompanying drawings, in which

FIG. 1 illustrates a device according to an embodiment of the present invention,

FIG. 2a illustrates a method according to an embodiment of the present invention,

FIG. 2b illustrates a method according to an embodiment of the present invention,

FIG. 3a illustrates a method according to an embodiment of the present invention, and

FIG. 3b illustrates a method according to an embodiment of the present invention.

### DETAILED DESCRIPTION OF THE INVENTION

In the following description of the various embodiments, reference is made to the accompanying drawings, which form a part hereof, and in which is shown by way of illustration various embodiments in which the invention may be practised. It is to be understood that other embodiments may be utilized, and structural and functional modifications may be made without departing from the scope of the present invention.

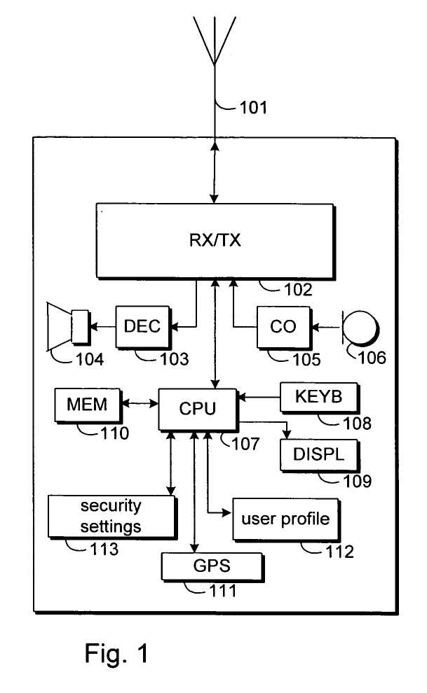

FIG. 1 illustrates an example of a device according to an embodiment of the present invention. A device of FIG. 1 has a control block 107, which manages all functions and other blocks of the device. Control block 107 handles and processes data, and transmits information between blocks. As an input means there is presented a keyboard 108. Devices may include other means for user input, such as mouse, pen or touch panel. As an output means there is presented a display 109 for presenting graphical and textual data.

FIG. 1 presents a microphone 106 for voice input. Inputted analog voices are coded to digital form by a coder 105. For voice and sound output there is presented a loudspeaker 104. Before digital sounds can be outputted by a loudspeaker 104, sounds are decoded to analog form by a decoder 103. The device of FIG. 1 has also memory block 110 for storing information and settings. Typically devices include different kind of memories, e.g. read-only memory (ROM), random access memory (RAM), flash memory, volatile and non-volatile memory. Memory has typically different data structures for different purposes in order to store and access data in the most suitable way.

In FIG. 1 there is a transceiver block 102 and an antenna 101 for establishing connections and for transmitting and receiving data, radio waves or signals through the connection established. Typically, connections are formed through a radio network to another devices, terminals, endpoints or nodes of the network.

Security settings are specified using a block 113. Typically, there are two determined security levels, namely secure and insecure. According to an embodiment of the invention, it is also possible to have more security levels, each including different determinations and settings regarding safety settings of a device. The settings include locking modes. According to an embodiment, security settings of block 113 are determined during the manufacturing phase and the user is typically not able to edit the settings. The stored security settings 113 are accessible for the user. The user can associate a locking mode to a certain feature of a device by associating a security level including a locking mode.

According to an embodiment of the present invention, security levels stored in settings in block 113 are presented in user profile 112. According to the embodiment the user may choose the wanted security level similarly as other items of the user profile. The security level setting is linked to a certain user profile and changed according to user profiles.

According to an embodiment of the present invention, locking modes are presented in the user profile 112 settings. According to the embodiment, the user may choose the wanted locking mode similarly as other items of the user profile. The chosen locking mode is associated to the user profile and the locking mode currently in use is chosen according to currently valid user profiles.

According to an embodiment of the present invention, the user can associate a certain locking mode to certain place. This is typically implemented by determining certain area, for example coordinates of the place. According to an embodiment certain often visited, insecure place is determined and a certain chosen, safe locking mode is associated to it. The present situation of the device is typically located with the aid of the Global Positioning System GPS 111, or some similar system for positioning the current location of the device. When the present coordinates or the location is detected to correspond to the predetermined, insecure place, to which a certain locking mode is associated to, the locking mode in question is set to be valid. When the locking mode is valid, it will be used for locking the device after the locking event is triggered manually by the user of automatically after a predetermined time of inactivity detected in the device. Typically, the certain locking mode is valid, as long as it is detected that the device is within the predetermined, insecure area.

According to an embodiment of the present invention, the user can associate a security level mode to certain place. When the present coordinates or the situation is detected to correspond to the determined, insecure place, for which certain security level is associated to, the security level in question is set to be valid. Typically, the certain security level is valid, i.e. the locking mode is used if the device is locked, as long as it is detected that the device is within the determined, insecure area.

Generally, there are different kinds of opening codes for different kinds of locking modes. An insecure locking mode having a key locking function for enabling handy and flexible use is typically released by inputting certain short key combination. The key combination is typically universal, common to all devices, thus basically anyone can release it. According to an embodiment, a second secure locking mode has a safe locking and closing function for protecting the device from an unauthorized access. The safe locking function is typically released by a code specified by the user. Thus, usually only the owner of the device knows the code and can release the safe device lock. According to embodiments of the invention, it is also possible to have multiple safe locking modes each having certain own specified features in order to be suitable for different situations and environments. A certain locking mode can be selected to be activated and used according to embodiments of the present invention. Releasing can be implemented according to the locking mode selected, although a commonly sensible number of releasing codes are employed. For example, two codes are typical in order to release locking codes classified as secure, and on the other hand locking codes classified as insecure, even though according to an embodiment, there can be few different locking codes having a bit different features under the each classification.

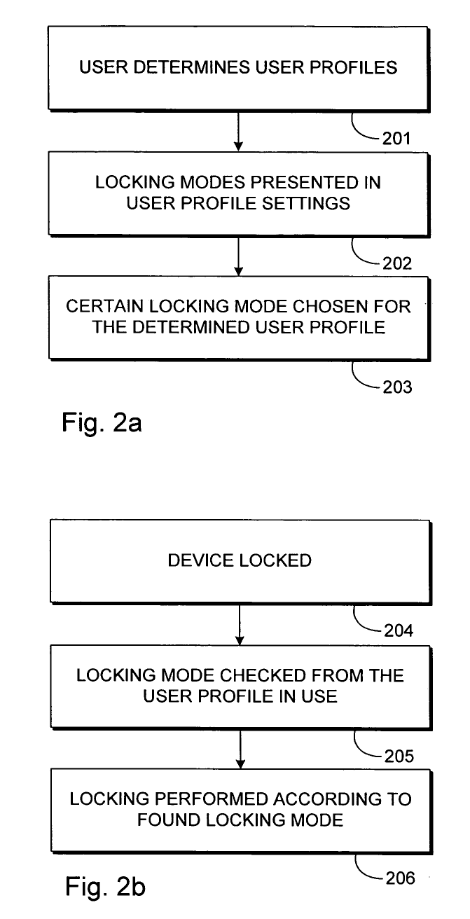

FIG. 2a presents a method according to an embodiment of the present invention. In phase 201 the user determines user profiles of the user device. Typically, there is determined several user profiles for different situations and environments. The user profiles typically include settings for ringing tone, loudness, alarm, and so on. The chosen features of the user profile depend on requirements of the environment or situation, wherein the user profile is to be used. According to an embodiment of the present invention, a locking mode is also a feature to be selected in the user profile. In phase 202 existing locking modes are presented as alternatives to the user in user profile settings. According to another embodiment, locking modes can alternatively or additionally be selected manually from the menu of the device. According to another embodiment, there is presented security level alternatives in phase 202 in user profile settings. The user can thus select a security level to be associated to the user profile, i.e. to be used when the user profile is valid to be used. The security level includes a certain locking mode to be used with the security level. The user selects the locking mode automatically by selecting a certain security level, since the security level includes locking mode determinations.

In this embodiment in phase 203 the user selects a locking mode from the alternatives presented in phase 202. The chosen locking mode is associated with the user profile. According to an embodiment, the user chooses a security level to be associated with the user profile in question. The chosen locking mode is then valid when the user profile is valid to be used, and thus activated by activating the user profile.

FIG. 2b presents a method according to an embodiment relating to locking the device after the determinations according to embodiment presented with the accompanying FIG. 2a are made. The device is locked in phase 204. A device is typically locked manually by certain constant command input by the user. In some devices locking is performed automatically after a certain period of inactivity, i.e. after the device has not been used for a certain period of time. Despite the triggering event for the locking of the device, after the device obtains a command to lock, the currently active locking mode or security level is determined in the user profile. The user profile currently valid for use is checked in order to discover the currently valid locking mode in phase 205. The currently valid locking mode can be determined in the user profile settings directly or through security level settings. The user profile may have some constant predetermined security level, which is used, when no locking mode is determined by the user. Typically, different user profiles have different security requirements and thus different selected locking modes and/or security levels. After the currently valid locking mode is found, the locking is performed according to it in phase 206. The locking is performed according to locking mode associated to the currently active user profile in phase 206.

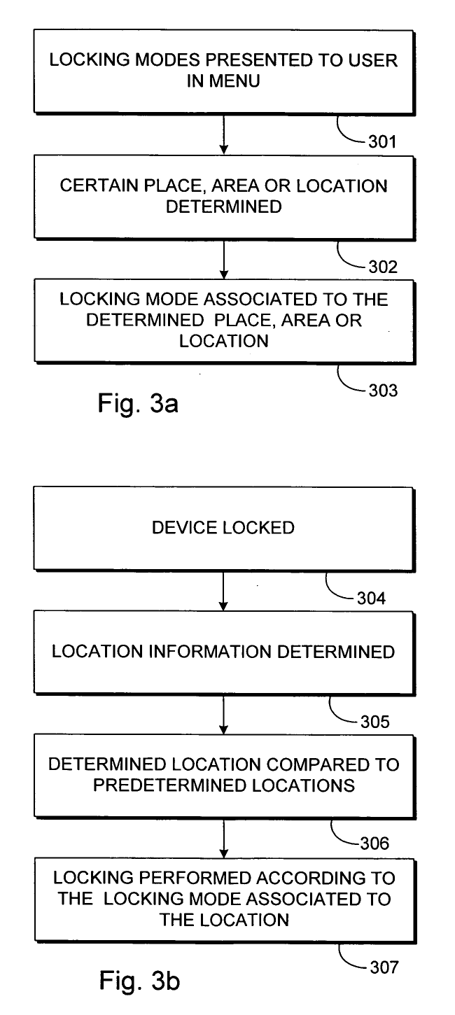

FIG. 3a presents a method according to an embodiment of the present invention. According to the embodiment, in phase 301 alternative locking modes are presented to the user in a menu. The user may choose a locking mode he desires to associate to certain determinable place, area or location. According to another embodiment, in phase 301 security levels including locking modes are presented to the user in a menu. The security levels including certain predetermined functions and settings are then presented to the user in phase 301 for the user to be able to choose the most applicable among those. The locking modes and/or security levels are predetermined possibly already in the manufacturing phase.

In the embodiment of FIG. 3a, the user determines certain place, area or location in phase 302. It is possible to determine place like a museum, theatre, park, stadium, market place, factory, or any other place requiring a certain level of security. Typically, a place, area or location is determined using its location information, which is determined for example using GPS equipment. In phase 303 the user associates the locking mode or the security level selected in phase 301, to the determined location information. Typically, often-visited places, which are determined to be insecure, i.e. requiring safe and secure settings for the mobile device, are associated with the high security level or secure locking mode.

FIG. 3b presents a method according to an embodiment relating to locking the device after the determinations according to the embodiment presented with the accompanying FIG. 3a are made. The device is locked in phase 304. A device is typically locked manually by certain constant command input by the user. In some devices, locking is performed automatically after a certain period of inactivity, i.e. after the device has not been used for a certain period of time. Despite of the triggering event for the locking of the device, after the device obtains a command to lock, the present location information of the device is determined in phase 305. Typically, the location information is verified with the Global Positioning System, GPS. It is also possible to check the current position of the mobile device from the radio network. Regardless of how the current position is determined, after the current position is verified, it is compared in phase 306 to predetermined location information to which certain security level or locking mode is associated. If, according to the current location information, the mobile device is found to be in the area to which certain locking mode and/or security level is linked, the locking is performed according to the locking mode predetermined to be used in the area in phase 307. Usually, some insecure places or locations are associated with high security level and/or secure locking mode. The assumption is to use low security level and/or insecure locking mode, unless the location information determined in phase 305 is found to correlate with the predetermined location information in phase 306 to which a secure locking mode is associated.

Embodiments relating to FIG. 2a and 2b, and embodiments relating to FIG. 3a and 3b are well fit to be realized together in the same device. The embodiments may be overlapping such that there is certain priority in between those. For example, it can be specified that the locking mode associated to a certain area or location always overrides a locking mode determined in the user profile settings. Further, there can be a locking mode determined manually to be used at the moment, which can be used as an assumption, if no other determination is found, e.g. associated to the determined current location information, or from the settings of the currently valid user profile. According to an embodiment of the present invention, a location information and possible security levels associated to it are checked first. When no locking mode or security level is found to be associated to the current location, the currently valid user profile is checked in order to find a locking mode or a security level determined in the user profile settings. According to another embodiment, the user profile is checked first. If no locking mode or security level is found, the location information is determined. It is also possible to check the location information and possible security levels associated to the current position of the device, when the security level of the user profile is found to be a predetermined constant, which is used if no other determinations is found.

According to an embodiment of the invention, the user uses a positioning service to record the position information of the most commonly visited locations. According to an embodiment in the user device, there is presumptive locking mode, which is used when nothing else is specified. According to the embodiment, the presumptive locking mode is safe-one, i.e. it locks the whole device, not only the keys, and is releasable only by a device-specific locking code. If the user considers some determined location, e.g. her office, to be secure, there is no need to use safe locking, but keyboard locking would be sufficient. According to embodiments, the user determine a certain location to be secure by associating only keyboard locking function to be performed on location in question. The mobile device traces its current location. While the device is on a location, which is determined to be secure and the device lock is activated, only the keyboard lock is turned on. On other locations, namely presumed or determined to be insecure, the secure locking code for protecting the device from unauthorized access is turned on.

What is claimed is:

1. A mobile device having an ability to be locked, including at least two separate locking modes having different locking features, associated to a certain feature, which is determinable in the device, and means for determining a currently valid locking mode, according to which the device is locked, according to the association between the feature and the locking mode.

2. The mobile device according to claim 1, including a first insecure locking mode having a key locking function for enabling handy and flexible use, and a second secure locking mode having a safe locking and closing function for protecting the device from an unauthorized access.

3. The mobile device according to claim 1, including means for presenting locking modes in a menu, and means for associating a certain locking mode to a feature determinable in a device manually from the menu.

4. The mobile device according to claim 1, including a security level indicating a degree of security needed, including a certain locking mode according to the degree of security of the certain security level, such that the security level is associated to a certain feature determinable in the device and the security level and the locking mode included in it are usable and valid when the feature, to which the security level is associated to, is valid.

5. The mobile device according to claim 1, including means for determining user profiles in the device, means for presenting locking modes in user profile settings, means for associating a chosen locking mode to a certain user profile, and means for activating the locking mode according to definitions of the currently valid user profile as a response to a triggered locking event.

6. The mobile device according to claim 5, including a security subsystem for checking a currently valid locking mode associated to a currently active profile as a response to a triggered locking event.

7. The mobile device according to claim 1, including means for determining a current location of the device, and means for associating a chosen locking mode to a certain predetermined location.

8. The mobile device according to claim 7, including means for comparing the determined, current location and the predetermined location having a certain locking mode associated to it, and means for activating the locking mode associated to the predetermined location, if the current location is found to correspond to the predetermined location, as a response to a triggered locking event.

9. A method for providing locking modes for mobile device, including steps of providing at least two separate locking modes having different locking features, the modes being associated to a certain feature, which is determinable in the device, and selecting the currently valid locking mode, according to which the device is locked, according to the association.

10. The method according to claim 9, including steps of associating a security level indicating a degree of security needed, including a certain locking mode according to the degree of security of the security level, to a certain feature determinable in the device, such that the security level and the locking mode included in it are valid to be used when the feature, to which the security level is associated to, is valid.

11. The method according to claim 9, including steps of choosing a certain locking mode from a user profile setting, and associating the chosen locking mode to a user profile such that the locking mode associated to the user profile is valid to be used in the locking event, when the user profile is valid.

12. The method according to claim 9, including steps of determining a certain location of a device, and associating certain predetermined locking mode to the determined location such that the locking mode associated to the certain location is valid to be used in the locking event, when the device is traced to situate at the predetermined location.

13. A method for locking a mobile device, as a response to a triggered locking event, including steps of:
checking a certain currently valid feature, which is determinable in the device, to which a locking mode is associated to,
determining the currently valid locking mode according to the association between the feature and the locking mode, and
implementing locking of the device according to currently valid locking mode.

14. The method according to claim 13, wherein a currently valid user profile is checked in order to determine the currently valid locking mode associated to it.

15. The method according to claim 13, comprising steps of tracing a current location of the device, comparing the current location to the predetermined location, to which a locking mode is associated to, and if the current location is found to correspond to the predetermined location, activating the locking mode associated to the predetermined location.

16. A computer program product comprising a computer readable medium having computer readable code for execution on a processor, the computer program product for locking a mobile device, the computer program product having
software means for providing at least two separate locking modes having different locking features,
software means for associating a locking mode to a certain feature of a device,
software means for checking a currently valid feature, to which a currently valid locking mode is associated to,
software means for determining a currently valid locking mode according to the association between locking mode and the feature, and
software means for locking the device according to the currently valid locking mode, as a response to triggering a locking event.

17. The computer program product according to claim 16, including a security level means indicating degree of security needed, having a certain locking mode associated to a certain security level according to the degree of security of the certain security level, software means for associating the security level to a certain feature determinable in the device, and software means for validation the security level and the locking mode associate to for use, when the feature, to which the security level is associated to, is valid.

18. The computer program product according to claim 16, including software means for associating a certain locking mode to a certain user profile, and software means for checking present locking mode from the user profile by a security subsystem in order to determine the currently valid locking mode associated to it.

19. The computer program product according to claim 16, including software means for tracing current location of the device, software means for associating a certain locking mode to a certain predetermined location, software means for comparing traced, current location to the predetermined location to which the certain locking mode is linked to, and software means for locking the device according to currently valid locking mode associated to predetermined location corresponding to the traced, current location.
